(19) United States
(12) Patent Application Publication
(10) Pub. No.: US 2004/0258269 A1
(43) Pub. Date: Dec. 23, 2004

(54) Loudspeaker assembly

(76) Inventors: Stephen Halsall, Tunbridge Wells (GB); Philip Jeffrey Anthony, Ashford (GB)

Correspondence Address: Kenneth L. Sherman, Esq., Myers Dawes Andras & Sherman, LLP, 11th Floor, 19900 MacArthur Blvd., Irvine, CA, 92612, US

(21) Appl. No.: 10/873,072

(22) Filed: Jun. 21, 2004

(30) Foreign Application Priority Data
Jun. 21, 2003 (GB) 0314524.0
Jan. 22, 2004 (GB) 0401387.6
Jun. 15, 2004 (GB) 0413361.7

(51) Int. Cl. H04R 1/00; H04R 1/02; H04R 11/02

(52) U.S. Cl. 381/387; 381/386; 381/412; 381/431

(57) ABSTRACT

The assembly comprises a loudspeaker drive unit having terminals for connection to an audio signal source. The drive unit has a chassis with a mounting ring which has first and second opposed surfaces for, respectively, abutment against a seating in a mounting ring and abutment by a retaining circlip. The mounting ring is retained in an aperture in, for example, a ceiling by spring clips. The design of the drive unit allows it to be substituted for the sealed halogen light bulb in a conventional light fitting having such a bulb. A simple and convenient way of mounting the loudspeaker, particularly in a ceiling in a room such as a kitchen or bathroom where space elsewhere is limited, is therefore provided. The invention also facilitates conversion between a light fitting to a speaker installation.

### BACKGROUND TO THE INVENTION

1. Field of the Invention

The present invention relates to loudspeakers and to arrangements for their mounting in apertures in planar support members, for example ceilings.

2. Description of the Prior Art

The provision of loudspeakers in an increasing number of different locations in buildings is becoming desirable. For example, in domestic buildings, the provision of loudspeakers forming parts of a sound system is desired in an increasing number of rooms where the sound system is to be heard. In many of these rooms, particularly kitchens and bathrooms, it is not convenient to provide freestanding or wall-mounted speaker enclosures.

### BRIEF SUMMARY OF THE INVENTION

It is therefore an object of the present invention to provide a loudspeaker assembly which includes a loudspeaker drive unit and which allows convenient and simple mounting in a planar support member, for example a ceiling.

It is a further object of the invention to provide a loudspeaker drive unit which can be used to replace the light bulb in the kind of light fitting which uses a 12V sealed halogen bulb, for example of 50 mm diameter, and a panel-mounted, preferably fully-recessed, fitting constituting a mounting means for the bulb or the drive unit.

Another object of the invention is to provide for the ready conversion of light-fittings of the kind just mentioned to loudspeaker installations and vice versa.

According to the present invention, there is provided a loudspeaker assembly for mounting in an aperture in a planar support member, for example a wall or a ceiling, the assembly comprising a mounting member to be received in the aperture in the planar member and a loudspeaker drive unit to be received in the mounting member,

the mounting member having means for its retention in a said aperture in a planar member and having an aperture for receiving the drive unit,

the mounting member providing a seating for the loudspeaker drive unit when inserted through the aperture in the mounting member in a first direction from a first side of the mounting member, the seating preventing the drive unit from moving further relative to the mounting member in the first direction, and

the assembly including a retaining means for retaining the drive unit in its seating in the mounting member and preventing its movement in a second, opposite direction.

Advantageously, the retaining means is accessible from the first side of the mounting member for removal of the drive unit therefrom.

Preferably, the mounting member is annular and the aperture therein is circular.

In such a case or otherwise, the seating preferably comprises a circular or part-circular flange on an internal surface of the mounting member.

The retaining means is advantageously a member which is removable from the mounting member, preferably from the first side thereof.

In such a case, the retaining member is conveniently a resilient part-annular member, such as a circlip, which abuts the drive unit to prevent its movement in the second direction and which expends radially to engage an internal surface of the mounting member.

Preferably, the drive unit has forward and rearward circular abutment surfaces, respectively for engagement with the seating on the mounting member and for engagement by the retaining means.

In other embodiments, the retaining means comprises an adhesive.

Conveniently, in a loudspeaker assembly according to the invention, the means for retention of the mounting member in the aperture comprises first and second spring clips on opposite sides of the mounting member.

Advantageously, the assembly includes a grille member in which the retaining means comprises an adhesive.

The mounting member can thus be a type which is used to form part of a known type of light fitting which commonly uses a 12V sealed halogen bulb of 50 mm diameter.

The invention also provides a loudspeaker drive unit for use in an assembly according to the invention, the drive unit comprising a chassis supporting a magnet assembly and a speaker cone, the chassis comprising an outwardly-extending circular mounting flange having first and second opposed faces for, respectively, abutment with the seating of the said mounting member and contact with the said retaining means.

Preferably the mounting flange forms the outermost portion of the unit.

Advantageously, the mounting flange has an external diameter of substantially 50 mm and can thus be received in a light fitting as mentioned above in substitution for the bulb of that fitting.

The invention accordingly also provides a method of converting a light-fitting of the sealed-halogen type to a loudspeaker installation, comprising removal of the sealed lamp from the fitting, disconnection of the lamp from its electrical supply, provision at the light-fitting of conductors supplying an audio signal, connection to the conductors of a drive unit according to the invention and mounting of the drive unit in the light fitting.

### BRIEF DESCRIPTION OF THE DRAWINGS

Embodiments of the invention will now be described by way of example with reference to the drawings of the specification, in which:

FIG. 1 is an exploded perspective view of a loudspeaker assembly according to the invention;

FIG. 2 is a front perspective view of the loudspeaker assembly of FIG. 1; and

FIG. 3 is a rear perspective view of the loudspeaker assembly;

FIG. 4 is a vertical sectional view of the loudspeaker assembly;

FIG. 5 is an exploded perspective view of a modified assembly; and

FIG. 6 is a front perspective view of the assembly of FIG. 5.

### DETAILED DESCRIPTION

The loudspeaker assembly shown in the drawings comprises a loudspeaker drive unit 10 and a mounting assembly which consists of a mounting ring 12, first and second annular sealing gaskets 14, 16 and a retaining circlip 18.

The mounting ring 12 is circular and has a central circular aperture 20 of approximately 50 mm diameter which receives the drive unit 10. The mounting ring 12 has an annular front surface 22, an external annular flange 24 and an internal cylindrical surface 26, which together form an annular recess 28 in the rear of the ring 12. The recess 28 is dimensioned to receive the first sealing gasket 14.

The mounting ring 12 is formed with a pair of diametrically opposed rearward extending lugs 30, each of which carries a spring retaining clip 32. Each retaining clip 32 is formed from a length of wire which is shaped to form a longer arm 34 and a shorter arm 36 which have between them torsion spring portions 38 which resist relative movement of the arms 34, 36 towards each other from the position shown in the drawings. The retaining clips 32 are pivotally mounted in on tabs (not visible in the drawings) extending into apertures 42 in the lugs 30 and therefore can pivot through a restricted arc relative to the lugs 30.

The mounting ring 12 is also formed internally with a shoulder 44 which is in two arcuate portions which each extend through an arc of about 160°. The two portions of the shoulder 44 provide a seating for the drive unit 10. The second annular sealing gasket 16 is dimensioned to locate on the shoulder 44 when the drive unit 10 and mounting ring 12 are assembled.

The drive unit 10 comprises a conventional loudspeaker cone 46 which is carried in the usual way by a coil (not visible in the drawings) which is movable within a gap within a magnet assembly 48. The cone 46 is attached around its circumference to a chassis 50 which consists of front and rear circular rings 52, 54 which are joined at intervals by axial portions 56. The chassis is of metal and die-cast but could alternatively be of pressed steel or a plastics material. The front ring 52 is larger in diameter than the rear ring 54 so that the chassis has an overall shape which is generally frusto-conical. The outer diameter of the front ring is about 50 mm in this embodiment. The rear ring 54 supports the magnet assembly 48. Electrical terminals 58 allow for electrical connections to be made to the drive unit for supply of an audio signal.

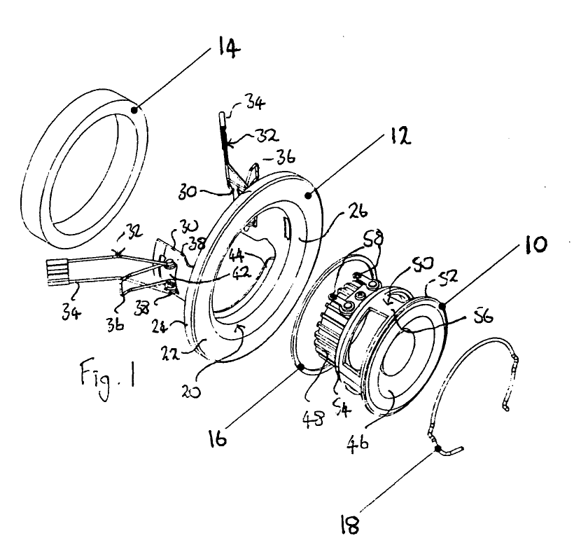

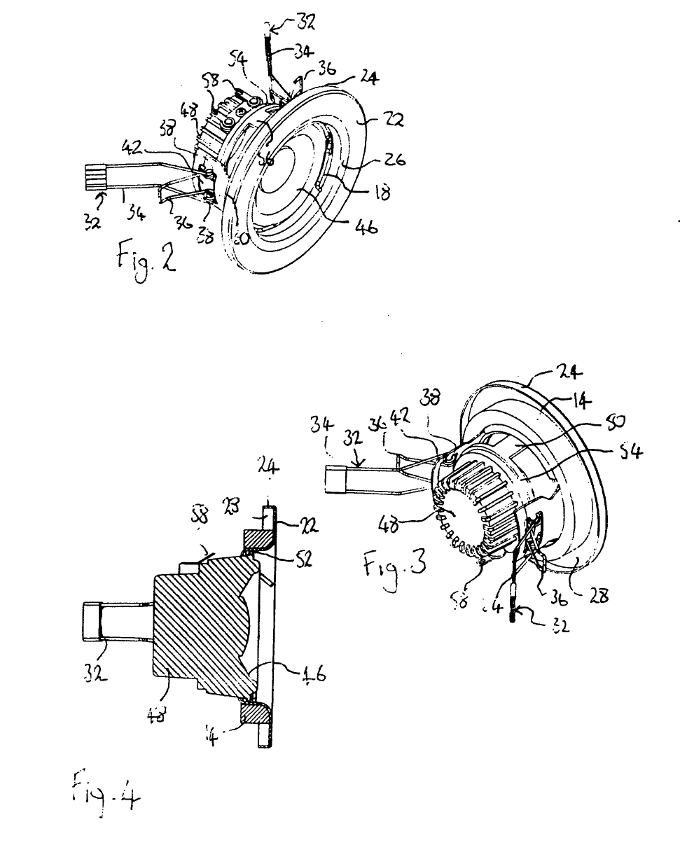

The drive unit 10 is mounted in the mounting ring 12 by insertion through the aperture 20 in the rearward direction from the front side of the ring 12 (from right to left in FIG. 1). This movement is continued until the front ring 52 of the drive unit chassis 50 becomes seated on the second sealing gasket 16 which rests on the shoulder 44. The shoulder 44 prevents further rearward movement of the drive unit relative to the mounting ring 12. The drive unit 10 may now be secured in the mounting ring 12 by means of the retaining circlip 18 which is first compressed (for example by use of a pair of circlip pliers) and then inserted into the circular aperture 20 into a position in which it rests just in front of the forward edge of the front ring 52 of the chassis 50 of the loudspeaker drive unit 10. On release, the retaining circlip 18 expands in diameter to press against the internal cylindrical surface 26 of the aperture 20 and thereby retains the loudspeaker drive unit 10 in the mounting ring 12. This is as shown in FIGS. 2 and 3.

Mounting of the loudspeaker assembly in an aperture in a planar support member, for example a ceiling, will now be described. Mounting may be carried out after the drive unit 10 has been assembled with the mounting ring 12 as described above or, alternatively, the mounting ring may first be secured in the aperture in the planar support member and the drive unit mounted in the mounting ring subsequently, again as described above.

Assuming the former situation, the first annular sealing gasket 14 is positioned in the recess 28 in the rear of the mounting ring 12. The assembly of the gasket 14 and mounting ring 12 is then offered up to the aperture in the ceiling. The ceiling aperture is circular and around 60 mm in diameter. In order to allow this, the longer arms 34 of the retaining clips 32 are manually squeezed towards each other until their free ends are spaced by a distance which allows them to pass through the ceiling aperture. Once the longer arms 34 have passed through the ceiling aperture, the manual grip on the arms 34 is released. The retaining clips 32 are now positioned such that the longer arms 34 lie above the surface of the ceiling and the shorter arms 36 lie below. Further movement of the mounting assembly into the ceiling aperture results in the clips 32 first pivoting on their mounting tabs and, when the longer arms 34 have made contact with the upper surface of the ceiling, in the shorter arms 36 engaging the inside surface of the aperture and being pressed inwards against the bias of the spring portions 38 until they lie between the inside surface of the aperture and the lugs 30. In this position the longer arms 34 are pressed against the upper surface of the ceiling by the bias of the spring portions 38. The mounting assembly is thus held in the ceiling aperture with the larger annular sealing gasket 14 compressed between the rearward face of the mounting ring 12, and the lower surface of the ceiling.

With the mounting assembly fixed in the ceiling as described, the loudspeaker drive unit 10 can be inserted into the mounting ring 12 and secured therein by use of the retaining circlip 18, as described above. Alternatively, the drive unit 10 can be first mounted in the mounting ring 12 as described above and the ring 12 then mounted in the ceiling aperture as described.

After having been mounted in the mounting assembly 10 in the way described, the loudspeaker drive unit 10 can be released from the mounting ring 12 by contraction of the retaining circlip 18 until it is released from the mounting ring 12 and can be withdrawn from the mounting ring in the forward direction.

It will be noted that the mounting assembly is suitable also for receiving a standard 50 mm sealed halogen light bulb in substitution for the loudspeaker drive unit 10. In this way, light bulbs and loudspeaker drive units can be freely exchanged between mounting assemblies mounted or in the way described above. Also, an existing lighting installation can be converted into a mounting for a loudspeaker and vice versa. It is of course necessary in each case for the light bulb or drive unit to be connected respectively to a suitable 12 volt electrical power supply or to an audio signal source for the drive unit.

Mounting is not restricted to ceilings: the planar support member can be any suitable support member, for example 5a wall.

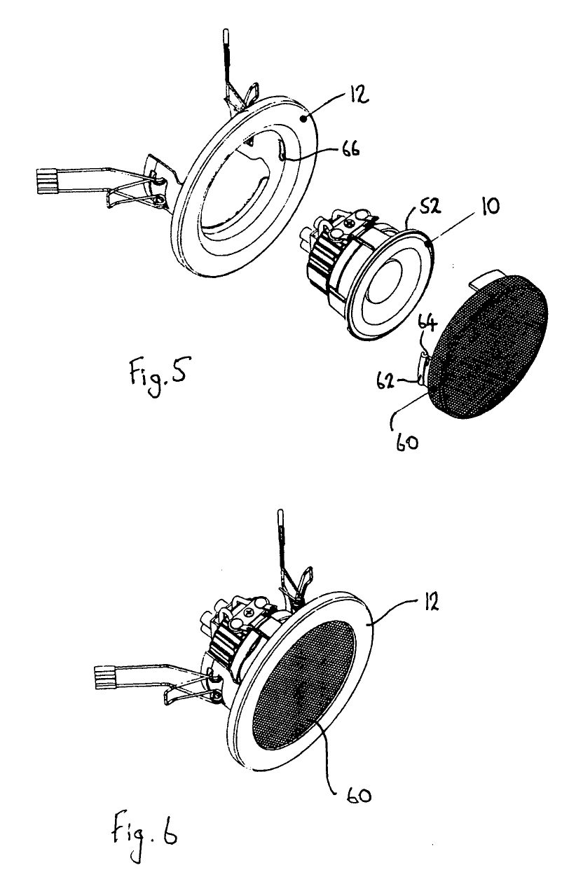

The modified assembly shown in FIGS. 5 and 6 of the drawings differs from that shown in FIGS. 1 to 4 firstly in that the circlip 18 is omitted together with the second seating gasket 16. The drive unit 10 is retained in the mounting ring 12 by means of adhesive applied to the front ring 52 of the drive unit chassis 50. Secondly, the front of the drive unit 10 is covered by a perforate grille member 60 that closes the circular aperture 20 of the mounting member 12. The grille member 60 is retained by reception of ridges 62 on diametrically-opposed tabs 64 in slots 66 in the mounting member 12. The features of retention of the drive unit by adhesive and the grille can be provided independently of each other and with or without the circlip 18: when the grille is provided without the adhesive, it will circlip, constitute the retaining means in the absence of the circlip.

The modified assembly is used in exactly the same way as the unmodified assembly, to consist an existing lighting installation, or otherwise as described above.

Whilst the invention has been illustrated and described in detail in the drawings and foregoing description, the illustration and description are not to be considered as restrictive in character, it being understood that only the preferred embodiments have been shown and described and that all changes and modifications that come within the spirit of the invention are desired to be protected.

We claim:

1. A loudspeaker assembly for mounting in an aperture in a planar support member, the assembly comprising a mounting member to be received in the aperture in the planar member and a loudspeaker drive unit to be received in the mounting member,
the mounting member having means for its retention in a said aperture in a planar member and having an aperture for receiving the drive unit,
the mounting member providing a seating for the loudspeaker drive unit when inserted through the aperture in the mounting member in a first direction from a first side of the mounting member, the seating preventing the drive unit from moving further relative to the mounting member in the first direction, and
the assembly including retaining means for retaining the drive unit in its seating in the mounting member and preventing its movement in a second, opposite direction.

2. A loudspeaker assembly according to claim 1, which the retaining means is accessible from the first side of the mounting member for removal of the drive unit therefrom.

3. A loudspeaker assembly according to claim 1, in which the mounting member is annular and the aperture therein is circular.

4. A loudspeaker assembly according to claim 1, in which the seating comprises a circular or part-circular flange on an internal surface of the mounting member.

5. A loudspeaker assembly according to claim 1, in which the retaining means is a member which is removable from the mounting member.

6. A loudspeaker assembly according to claim 5, in which the retaining member is a resilient part-annular member which abuts the drive unit to prevent its movement in the second direction and which expends radially to engage an internal surface of the mounting member.

7. A loudspeaker assembly according to claim 1, in which the drive unit has forward and rearward circular abutment surfaces, respectively for engagement with the seating on the mounting member and for engagement by the retaining means.

8. A loudspeaker assembly according to claim 1, in which the retaining means comprises an adhesive.

9. A loudspeaker assembly according to claim 1, in which the means for retention of the mounting member in the aperture comprises first and second spring clips on opposite sides of the mounting member.

10. A loudspeaker assembly according to claim 1, including a grille member extending over the aperture in the mounting member to cover the drive unit.

11. A loudspeaker drive unit for use in an assembly according to claim 1, the drive unit comprising a chassis supporting a magnet assembly and a speaker cone, the chassis comprising an outwardly-extending circular mounting flange having first and second opposed faces for, respectively, abutment with the seating of the said mounting member and contact with the said retaining means.

12. A loudspeaker drive unit according to claim 11, in which the mounting flange forms the outermost portion of the unit.

13. A loudspeaker drive unit according to claim 12, in which the mounting flange has an external diameter of substantially 50 mm.

14. A method of converting a light-fitting of the sealed-halogen type to a loudspeaker installation, comprising removal of the sealed lamp from the fitting, disconnection of the lamp from its electrical supply, provision at the light-fitting of conductors supplying an audio signal, connection to the conductors of a drive unit according to claim 11, and mounting of the drive unit in the light fitting.
